(19) United States
(12) Patent Application Publication
(10) Pub. No.: US 2014/0354955 A1
(43) Pub. Date: Dec. 4, 2014

(54) Stereoscopic Image Projection Apparatus and Optical Module

(71) Applicant: Funai Electric Co., Ltd., Osaka (JP)

(72) Inventor: Atsushi IKEDA, Daito-shi (JP)

(73) Assignee: Funai Electric Co., Ltd., Osaka (JP)

(21) Appl. No.: 14/283,365

(22) Filed: May 21, 2014

(30) Foreign Application Priority Data
Jun. 4, 2013 (JP) 2013-117907

(51) Int. Cl. G02B 27/22

(52) U.S. Cl. CPC G02B 27/2214
USPC 353/7

(57) ABSTRACT

A stereoscopic image projection apparatus includes a projection portion emitting laser beams, a microlens array diffusing the laser beams from the projection portion, and a plane-symmetric imaging element projecting a stereoscopic projection image onto a position plane-symmetric to the microlens array by internally reflecting the laser beams from the microlens array and emitting the laser beams to an opposite side to the microlens array. The microlens array is arranged to be inclined with respect to the plane-symmetric imaging element.

### BACKGROUND OF THE INVENTION

1. Field of the Invention

The present invention relates to a stereoscopic image projection apparatus and an optical module, and more particularly, it relates to a stereoscopic image projection apparatus and an optical module each including a plane-symmetric imaging element projecting a stereoscopic projection image.

2. Description of the Background Art

A stereoscopic image projection apparatus including a plane-symmetric imaging element projecting a stereoscopic projection image is known in general, as disclosed in Japanese Patent Laying-Open No. 2011-081296.

The aforementioned Japanese Patent Laying-Open No. 2011-081296 discloses a display device (stereoscopic image projection apparatus) including a liquid crystal display (projection portion) and a reflection type plane-symmetric imaging element (plane-symmetric imaging element). This display device is configured to project an aerial image (stereoscopic projection image) onto a position plane-symmetric to the liquid crystal display about the reflection type plane-symmetric imaging element by reflecting and transmitting a light beam emitted from the liquid crystal display by the reflection type plane-symmetric imaging element.

In the display device according to the aforementioned Japanese Patent Laying-Open No. 2011-081296, however, the liquid crystal display having a wide viewing angle is employed as a light source, so that light from the liquid crystal display is diffused in all directions, and little light conceivably reaches the reflection type plane-symmetric imaging element (plane-symmetric imaging element). Therefore, the energy loss of light is increased. In other words, only part of the light from the liquid crystal display is utilized for the formation of the aerial image (stereoscopic projection image) by the reflection type plane-symmetric imaging element, whereby the light use efficiency is reduced and consequently the luminance of the aerial image is disadvantageously reduced.

### SUMMARY OF THE INVENTION

The present invention has been proposed in order to solve the aforementioned problem, and an object of the present invention is to provide a stereoscopic image projection apparatus and an optical module each capable of increasing the luminance of a stereoscopic projection image by increasing the light use efficiency of a laser beam from a projection portion.

A stereoscopic image projection apparatus according to a first aspect of the present invention includes a projection portion scanning and emitting laser beams to project a stereoscopic projection image, a microlens array diffusing the laser beams in a state where the diffusion angle of the laser beams from the projection portion is controlled to a prescribed angle, and a plane-symmetric imaging element to which the microlens array applies the laser beams whose diffusion angle is controlled, projecting the stereoscopic projection image onto a position plane-symmetric to the microlens array by internally reflecting the laser beams from the microlens array and emitting the laser beams to an opposite side to the microlens array, while the microlens array is arranged to be inclined with respect to the plane-symmetric imaging element.

As hereinabove described, the stereoscopic image projection apparatus according to the first aspect of the present invention is provided with the microlens array diffusing the laser beams from the projection portion at the prescribed angle, controlling the diffusion angle and the plane-symmetric imaging element to which the microlens array applies the laser beams whose diffusion angle is controlled, projecting the stereoscopic projection image onto the position plane-symmetric to the microlens array by internally reflecting the laser beams from the microlens array and emitting the laser beams to the opposite side to the microlens array. Thus, the microlens array diffuses the laser beams whose diffusion angle is controlled to the prescribed angle, whereby emission of the laser beams in a direction other than an intended direction can be suppressed. Therefore, generation of the laser beams not reaching the plane-symmetric imaging element can be suppressed, and the energy loss resulting from the laser beams not reaching the plane-symmetric imaging element can be reduced. Consequently, the light use efficiency of the laser beams from the projection portion is increased, whereby the luminance of the stereoscopic projection image projected by the plane-symmetric imaging element can be increased. Furthermore, the microlens array is arranged to be inclined with respect to the plane-symmetric imaging element, whereby the stereoscopic projection image can be projected onto the position plane-symmetric to the microlens array with respect to the plane-symmetric imaging element.

In the aforementioned stereoscopic image projection apparatus according to the first aspect, the microlens array is preferably configured to apply substantially all of the laser beams to the plane-symmetric imaging element by controlling the diffusion angle of the laser beams. According to this structure, substantially all of the laser beams are applied to a region on the plane-symmetric imaging element, and hence the energy loss of light can be easily reduced.

In the aforementioned stereoscopic image projection apparatus according to the first aspect, the microlens array preferably includes a plurality of lens portions formed on a surface thereof and is preferably arranged in a matrix such that the lens portions are adjacent to each other. According to this structure, the lens portions are arranged in the large area of the surface of the microlens array, and hence the light use efficiency can be further increased.

In this case, a region between the lens portions adjacent to each other is preferably flattened. According to this structure, the surface shape of the microlens array can be simplified, and hence the microlens array can be easily formed.

The aforementioned stereoscopic image projection apparatus according to the first aspect preferably further includes a correcting lens arranged to be inclined with respect to the plane-symmetric imaging element, arranged to be substantially parallel to the microlens array, and correcting the laser beams from the projection portion to be parallel to each other so that the laser beams from the projection portion are substantially perpendicularly incident on the microlens array. According to this structure, the laser beams are substantially perpendicularly incident on the microlens array, and hence the diffusion angle of the laser beams diffused by the microlens array can be more accurately controlled to the prescribed angle.

In the aforementioned stereoscopic image projection apparatus according to the first aspect, the microlens array preferably has a plurality of application regions of the laser beams and is preferably configured to emit the laser beams with different diffusion angles by having different surface shapes on the microlens array according to the plurality of application regions. According to this structure, the diffusion angles can be controlled according to the application regions of the microlens array, and hence the laser beams can be diffused at the different diffusion angles according to positions in the plane-symmetric imaging element.

In this case, the microlens array preferably has such a surface shape that a diffusion angle in an application region emitting the laser beams to the side of the plane-symmetric imaging element far away from the microlens array becomes smaller than a diffusion angle in an application region emitting the laser beams to the side of the plane-symmetric imaging element close to the microlens array. The microlens array is inclined with respect to the plane-symmetric imaging element, whereby the laser beams are applied to a wider range on the side of the plane-symmetric imaging element far away from the microlens array than on the side of the plane-symmetric imaging element close to the microlens array. Therefore, the diffusion angle in the application region emitting the laser beams to the side of the plane-symmetric imaging element far away from the microlens array is reduced, whereby the region on the plane-symmetric imaging element to which the laser beams are applied can be reduced in size on the side far away from the microlens array. Thus, the plane-symmetric imaging element can be reduced in size, and hence the stereoscopic image projection apparatus can be downsized.

In the aforementioned structure in which the diffusion angle of the laser beams to the side of the plane-symmetric imaging element far away from the microlens array is smaller than the diffusion angle of the laser beams to the side of the plane-symmetric imaging element close to the microlens array, the application regions of the microlens array preferably include a first application region emitting the laser beams to the side of the plane-symmetric imaging element close to the microlens array with a relatively large diffusion angle and a second application region emitting the laser beams to the side of the plane-symmetric imaging element far away from the microlens array with a relatively small diffusion angle. According to this structure, diffusion of the laser beams is suppressed on the side far away from the microlens array while application of the laser beams to only a small region on the plane-symmetric imaging element is suppressed by diffusing the laser beams to a wide range on the side close to the microlens array, whereby an increase in the size of the region on the plane-symmetric imaging element to which the laser beams are applied can be suppressed.

In the aforementioned structure in which the application regions include the first application region and the second application region, the microlens array preferably includes a first lens part corresponding to the first application region and a second lens part corresponding to the second application region bonded to each other. According to this structure, the first application region and the second application region having the different diffusion angles can be easily formed simply by bonding the first lens part and the second lens part to each other.

In the aforementioned structure in which the application regions include the first application region and the second application region, the microlens array preferably includes a plurality of lens portions formed on a surface thereof, and on the surface inclined with respect to the plane-symmetric imaging element, a lens portion of the first application region is preferably formed elliptically to extend in a first direction parallel to the plane-symmetric imaging element while a lens portion of the second application region is preferably formed circularly. According to this structure, the lens portions are formed in the curved smooth surface shapes, and hence the stereoscopic projection image can be projected without unevenness.

In the aforementioned structure in which the application regions include the first application region and the second application region, the microlens array is preferably configured such that the diffusion angles are gradually reduced from the first application region toward the second application region. According to this structure, the diffusion angles are not sharply reduced in a boundary between the first application region and the second application region, and hence projection of the boundary between the first application region and the second application region into the stereoscopic projection image can be suppressed.

In the aforementioned structure in which the diffusion angles of the microlens array are gradually reduced from the first application region toward the second application region, the microlens array is preferably formed to extend in a first direction parallel to the plane-symmetric imaging element and in a second direction orthogonal to the first direction, inclined with respect to the plane-symmetric imaging element and is preferably configured such that the widths of lens portions in the second direction are increased from the first application region toward the second application region on a surface inclined with respect to the plane-symmetric imaging element. According to this structure, the diffusion angles of the laser beams can be adjusted by varying the widths of the lens portions in the second direction, and hence an increase in the size of the microlens array in a thickness direction can be suppressed.

In the aforementioned structure in which the widths of the lens portions of the microlens array in the second direction are increased from the first application region toward the second application region, the microlens array is preferably formed such that the thickness thereof in a direction orthogonal to the first direction and the second direction is uniform. According to this structure, the microlens array can be easily formed.

In the aforementioned stereoscopic image projection apparatus according to the first aspect, the plane-symmetric imaging element preferably includes two light control panels extending in a prescribed direction, having reflection surfaces reflecting the laser beams, the two light control panels are preferably arranged such that the reflection surfaces are orthogonal to each other while the two light control panels are brought into close contact with each other, and the plane-symmetric imaging element is preferably arranged at a position where the laser beams can be emitted to the position plane-symmetric to the microlens array about the plane-symmetric imaging element by reflecting the laser beams by the reflection surfaces of the two light control panels. According to this structure, the laser beams can be emitted to the position plane-symmetric to the microlens array by reflecting the laser beams a small number of times by the reflection surfaces of the two light control panels. Thus, the energy loss of light can be reduced, and the light use efficiency of the laser beams can be increased.

In the aforementioned structure further including the correcting lens, the correcting lens preferably includes a Fresnel lens. According to this structure, the correcting lens can be thinned, and hence the stereoscopic image projection apparatus can be downsized.

An optical module according to a second aspect of the present invention includes a microlens array diffusing laser beams in a state where the diffusion angle of the laser beams from a projection portion scanning and emitting the laser beams to project a stereoscopic projection image is controlled to a prescribed angle and a plane-symmetric imaging element to which the microlens array applies the laser beams whose diffusion angle is controlled, projecting the stereoscopic projection image onto a position plane-symmetric to the microlens array by internally reflecting the laser beams from the microlens array and emitting the laser beams to an opposite side to the microlens array, while the microlens array is arranged to be inclined with respect to the plane-symmetric imaging element.

As hereinabove described, the optical module according to the second aspect of the present invention is provided with the microlens array diffusing the laser beams from the projection portion at the prescribed angle, controlling the diffusion angle and the plane-symmetric imaging element to which the microlens array applies the laser beams whose diffusion angle is controlled, projecting the stereoscopic projection image onto the position plane-symmetric to the microlens array by internally reflecting the laser beams from the microlens array and emitting the laser beams to the opposite side to the microlens array. Thus, the microlens array diffuses the laser beams whose diffusion angle is controlled to the prescribed angle, whereby emission of the laser beams in a direction other than an intended direction can be suppressed. Therefore, generation of the laser beams not reaching the plane-symmetric imaging element can be suppressed, and the energy loss resulting from the laser beams not reaching the plane-symmetric imaging element can be reduced. Consequently, the light use efficiency of the laser beams from the projection portion is increased, whereby the luminance of the stereoscopic projection image projected by the plane-symmetric imaging element can be increased. Furthermore, the microlens array is arranged to be inclined with respect to the plane-symmetric imaging element, whereby the stereoscopic projection image can be projected onto the position plane-symmetric to the microlens array with respect to the plane-symmetric imaging element.

In the aforementioned optical module according to the second aspect, the microlens array is preferably configured to apply substantially all of the laser beams to the plane-symmetric imaging element by controlling the diffusion angle of the laser beams. According to this structure, substantially all of the laser beams are applied to a region on the plane-symmetric imaging element, and hence the energy loss of light can be easily reduced.

The aforementioned optical module according to the second aspect preferably further includes a correcting lens arranged to be inclined with respect to the plane-symmetric imaging element, arranged to be substantially parallel to the microlens array, and correcting the laser beams from the projection portion to be parallel to each other so that the laser beams from the projection portion are substantially perpendicularly incident on the microlens array. According to this structure, the laser beams are substantially perpendicularly incident on the microlens array, and hence the diffusion angle of the laser beams diffused by the microlens array can be more accurately controlled to the prescribed angle.

In the aforementioned optical module according to the second aspect, the microlens array preferably has a plurality of application regions of the laser beams and is preferably configured to emit the laser beams with different diffusion angles by having different surface shapes on the microlens array according to the plurality of application regions. According to this structure, the diffusion angles can be controlled according to the application regions of the microlens array, and hence the laser beams can be diffused at the different diffusion angles according to positions in the plane-symmetric imaging element.

In this case, the microlens array preferably has such a surface shape that a diffusion angle in an application region emitting the laser beams to the side of the plane-symmetric imaging element far away from the microlens array becomes smaller than a diffusion angle in an application region emitting the laser beams to the side of the plane-symmetric imaging element close to the microlens array. The microlens array is inclined with respect to the plane-symmetric imaging element, whereby the laser beams are applied to a wider range on the side of the plane-symmetric imaging element far away from the microlens array than on the side of the plane-symmetric imaging element close to the microlens array. Therefore, the diffusion angle in the application region emitting the laser beams to the side of the plane-symmetric imaging element far away from the microlens array is reduced, whereby the region on the plane-symmetric imaging element to which the laser beams are applied can be reduced in size on the side far away from the microlens array. Thus, the plane-symmetric imaging element can be reduced in size, and hence the stereoscopic image projection apparatus can be downsized.

According to the present invention, as hereinabove described, the light use efficiency of the laser beams from the projection portion is increased, whereby the luminance of the stereoscopic projection image can be increased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall structure of a stereoscopic image projection apparatus according to a first embodiment of the present invention;

FIG. 2 is a block diagram showing the structure of a scanning projector of the stereoscopic image projection apparatus according to the first embodiment of the present invention;

FIG. 3 is a plan view showing the structure of a microlens array of the stereoscopic image projection apparatus according to the first embodiment of the present invention;

FIG. 4 is a sectional view taken along the line 400-400 in FIG. 3;

FIG. 5 is a bottom view showing a state where a laser beam is applied to a plane-symmetric imaging element of the stereoscopic image projection apparatus according to the first embodiment of the present invention;

FIG. 6 is a perspective view showing the structure of the plane-symmetric imaging element of the stereoscopic image projection apparatus according to the first embodiment of the present invention;

FIG. 7 is a diagram for illustrating the projection principle of the plane-symmetric imaging element of the stereoscopic image projection apparatus according to the first embodiment of the present invention;

FIG. 8 is a diagram showing the overall structure of a stereoscopic image projection apparatus according to each of second and third embodiments of the present invention;

FIG. 9 is a plan view showing the structure of a microlens array of the stereoscopic image projection apparatus according to the second embodiment of the present invention;

FIG. 10 is a sectional view taken along the line 500-500 in FIG. 9;

FIG. 11 is a plan view showing the structure of a microlens array of the stereoscopic image projection apparatus according to the third embodiment of the present invention; and

FIG. 12 is a sectional view taken along the line 600-600 in FIG. 11.

### DESCRIPTION OF THE PREFERRED EMBODIMENTS

Embodiments of the present invention are hereinafter described with reference to the drawings.

### First Embodiment

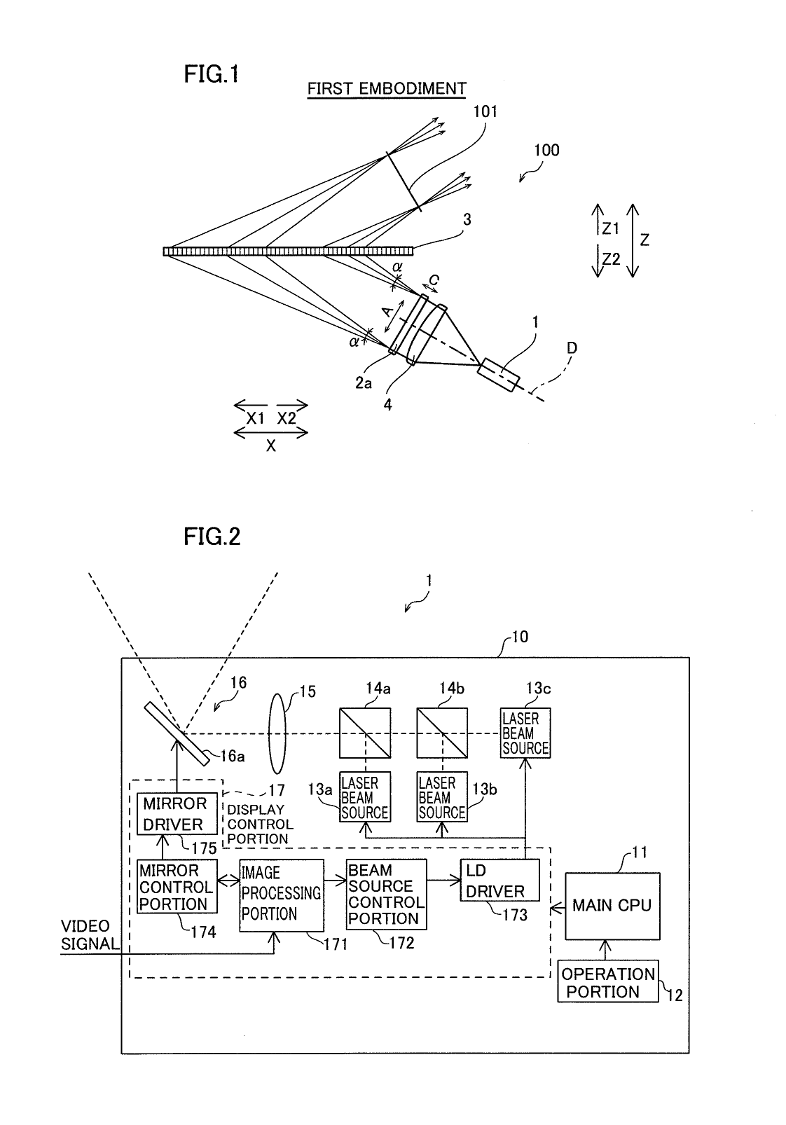

The structure of a stereoscopic image projection apparatus 100 according to a first embodiment of the present invention is now described with reference to FIGS. 1 to 7.

The stereoscopic image projection apparatus 100 according to the first embodiment is configured to project a stereoscopic projection image 101 onto a space by reflecting laser beams by a plane-symmetric imaging element 3, as shown in FIG. 1. More specifically, the stereoscopic image projection apparatus 100 includes a scanning projector 1 scanning and emitting the laser beams to project the stereoscopic projection image 101, a microlens array 2a diffusing the laser beams in a state where the diffusion angle of the laser beams from the scanning projector 1 is controlled to a prescribed angle (α), and the plane-symmetric imaging element 3 to which the microlens array 2a applies the laser beams whose diffusion angle is controlled, projecting the stereoscopic projection image 101 onto a position plane-symmetric to the microlens array 2a by internally reflecting the laser beams from the microlens array 2a and emitting the laser beams to an opposite side (in a direction Z1) to the microlens array 2a. The microlens array 2a is arranged to be inclined with respect to the plane-symmetric imaging element 3. A Fresnel lens 4 corrects the laser beams to be parallel to each other, whereby the laser beams are substantially perpendicularly applied to the microlens array 2a. The scanning projector 1 is an example of the “projection portion” in the present invention. The Fresnel lens 4 is an example of the “correcting lens” in the present invention. Each component of the stereoscopic image projection apparatus 100 is now described.

First, the structure of an optical system used to apply the laser beams to the plane-symmetric imaging element 3 is described. In other words, the scanning projector 1, the Fresnel lens 4, and the microlens array 2a are described.

The scanning projector 1, the Fresnel lens 4, and the microlens array 2a are arranged in series on the same axis (axis D) extending inclinedly with respect to the plane-symmetric imaging element 3, as shown in FIG. 1. The Fresnel lens 4 is arranged parallel to the microlens array 2a.

The scanning projector 1 includes a main CPU 11, an operation portion 12, three (blue (B), green (G), and red (R)) laser beam sources 13a to 13c, two beam splitters 14a and 14b, a condensing lens 15, a laser beam scanning portion 16, and a display control portion 17, as shown in FIG. 2. The stereoscopic projection image 101 projected onto the space is formed by the laser beams emitted from the laser beam sources 13a to 13c. The laser beam scanning portion 16 includes a MEMS (Micro Electro Mechanical System) mirror 16a. The display control portion 17 includes an image processing portion 171, a beam source control portion 172, an LD (laser diode) driver 173, a mirror control portion 174, and a mirror driver 175. The scanning projector 1 is configured to emit the laser beams for projecting the stereoscopic projection image 101 to the Fresnel lens 4 on the basis of a video signal input into the image processing portion 171.

The main CPU 11 is configured to control each portion of the scanning projector 1. The operation portion 12 is provided to accept an operation of turning on the scanning projector 1 etc. The laser beam source 13a is configured to emit a blue laser beam to the MEMS mirror 16a through the beam splitter 14a and the condensing lens 15. The laser beam sources 13b and 13c are configured to emit a green laser beam and a red laser beam, respectively, to the MEMS mirror 16a through the beam splitters 14a and 14b and the condensing lens 15. The laser beam sources 103 to 105 are configured to be capable of emitting the laser beams corresponding to colors of 0 to 255 gradations.

The laser beam scanning portion 16 is configured to project the laser beams to the microlens array 2a. Specifically, the MEMS mirror 16a of the laser beam scanning portion 16 is configured to scan the laser beams emitted from the laser beam sources 13a to 13c and project the stereoscopic projection image 101 on the microlens array 2a. The MEMS mirror 16a is configured to be driven along two axes in a horizontal direction and a vertical direction and scan the laser beams. The MEMS mirror 16a is configured to scan the horizontal direction at a high speed by resonance driving and to scan the vertical direction at a low speed by DC driving.

The image processing portion 171 is configured to control the projection of the stereoscopic projection image 101 with the laser beams on the basis of the video signal externally input. Specifically, the image processing portion 171 is configured to control the driving of the MEMS mirror 16a through the mirror control portion 174 and control the emission of the laser beams from the laser beam sources 13a to 13c through the beam source control portion 172 on the basis of the video signal externally input.

The beam source control portion 172 is configured to control the LD driver 173 on the basis of the control performed by the image processing portion 171 and control the emission of the laser beams from the laser beam sources 13a to 13c. Specifically, the beam source control portion 172 is configured to control the laser beam sources 13a to 13c to emit the laser beams of colors corresponding to pixels of the video signal in synchronization with the scanning timing of the MEMS mirror 16a.

The mirror control portion 174 is configured to control the mirror driver 175 on the basis of the control performed by the image processing portion 171 and control the driving of the MEMS mirror 16a.

The Fresnel lens 4 is configured to correct the directions of the transmitted laser beams to be parallel to each other (parallel to the axis D) by internally refracting the laser beams from the scanning projector 1, as shown in FIG. 1. It is necessary to place the laser beam sources at the focal length of the Fresnel lens 4 in order for the Fresnel lens 4 to correct the laser beams to be parallel to each other. Therefore, the scanning projector 1 is arranged to emit the laser beams from a position spaced at a prescribed distance from the Fresnel lens 4 on the axis D in view of the focal length of the Fresnel lens 4. Consequently, the Fresnel lens 4 is configured to be capable of correcting the laser beams to be substantially perpendicular to the microlens array 2a to apply the laser beams thereto.

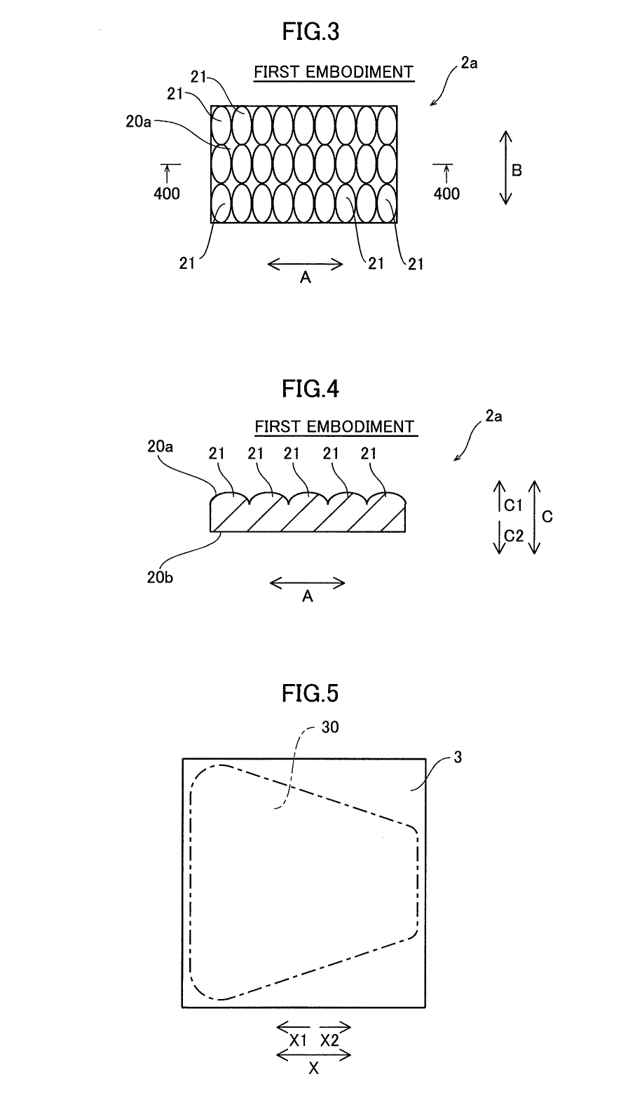

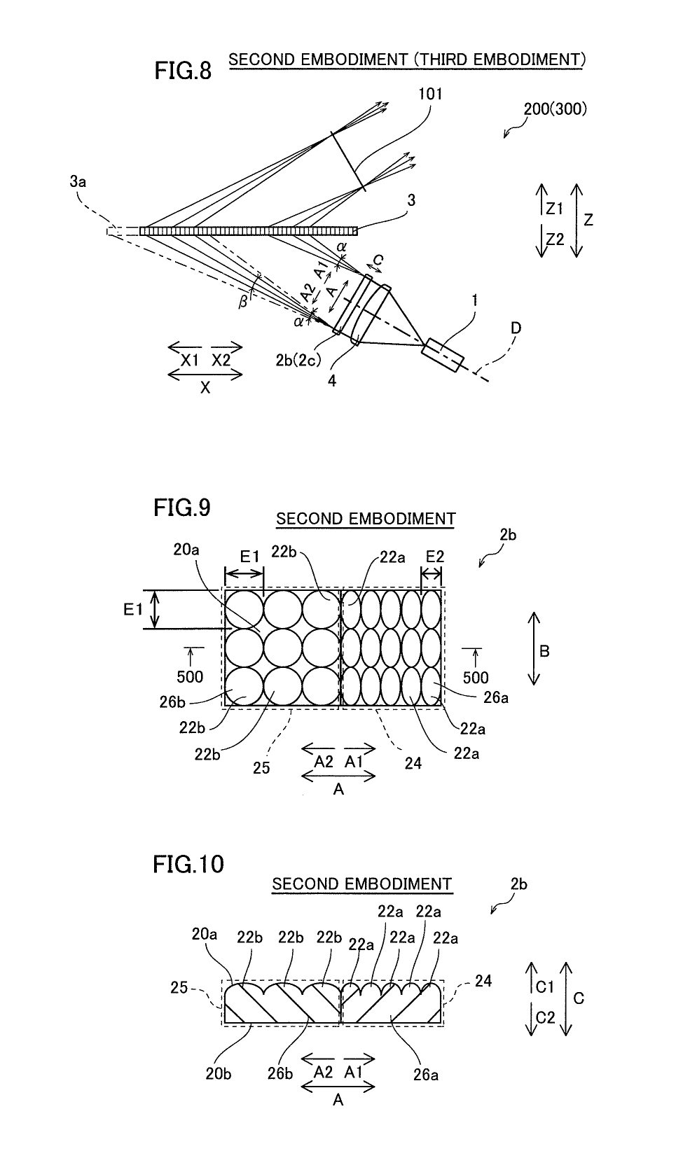

The microlens array 2a is provided in the form of a rectangular flat plate, as shown in FIGS. 3 and 4. Directions A, B, and C shown in FIGS. 3 and 4 are orthogonal to each other. The directions A and C are along straight lines parallel to a plane in FIG. 1, similarly to directions X and Z. In the microlens array 2a shown in FIGS. 3 and 4, convex lens portions are illustrated larger than actual size for the purpose of illustration of the surface shape. The same applies to FIGS. 9 to 12 showing microlens arrays 2b and 2c according to the following second and third embodiments. The direction A is an example of the “second direction” in the present invention. The direction B is an example of the “first direction” in the present invention.

The microlens array 2a is formed such that a first surface 20a (in a direction C1) has a plurality of lens portions 21 and a second surface 20b (in a direction C2) is substantially flat, as shown in FIG. 4. More specifically, the microlens array 2a is formed by covering (plane-filling) the surface 20a with the plurality of lens portions 21 in a plan view. This plurality of lens portions 21 are formed elliptically in the plan view and convexly in a side view. Furthermore, the plurality of lens portions 21 of the microlens array 2a are arranged in a matrix (in a grid pattern) such that lens pitches between the adjacent lens portions 21 are equal to each other. The surface 20b of the microlens array 2a in the direction C2 is configured to receive the laser beams emitted from the scanning projector 1 (see FIG. 1) and corrected to be parallel to each other by the Fresnel lens 4 (see FIG. 1).

According to the first embodiment, in the microlens array 2a, the same convex lens portions 21 cover the surface 20a to form the surface shape, as described above. Consequently, the microlens array 2a is configured to be capable of diffusing the laser beams at a prescribed diffusion angle (α) by refracting the laser beams by the lens portions 21 in the side view, as shown in FIG. 1. Consequently, each of the lens portions 21 is configured to be a point light source. The diffusion angle of the laser beams can be controlled by the surface shape of the microlens array 2a. Consequently, the microlens array 2a is configured to be capable of applying substantially all of the laser beams to a prescribed region 30 on the plane-symmetric imaging element 3, as shown in FIG. 5. Thus, the stereoscopic image projection apparatus 100 is configured to be capable of reducing the energy loss of light by reducing the laser beams not reaching the plane-symmetric imaging element 3.

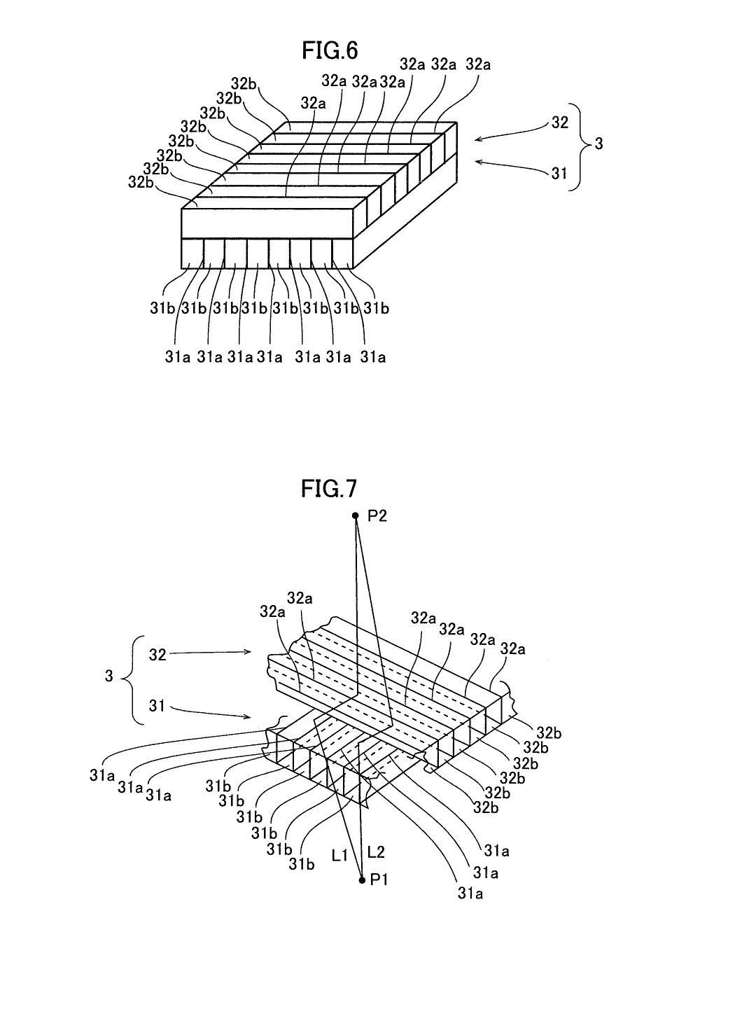

The structure of the plane-symmetric imaging element 3 is now described with reference to FIGS. 6 and 7.

The plane-symmetric imaging element 3 is formed in a stacked manner by bringing two transparent flat plate-shaped light control panels 31 and 32 into close contact with each other and bonding the same to each other, as shown in FIGS. 6 and 7. Specifically, the light control panel 31 has a plurality of reflection surfaces 31a reflecting the laser beams. The light control panel 31 is configured to extend in a thickness direction and be divided into a plurality of band bodies 31b by the plurality of reflection surfaces 31a arranged parallel to each other at prescribed pitches. The light control panel 32 is also configured to be divided into a plurality of band bodies 32b by a plurality of reflection surfaces 32a, similarly to the light control panel 31. The plane-symmetric imaging element 3 is formed in the stacked manner by bonding the light control panels 31 and 32 to each other in a state where the band bodies 31b and 32b thereof are orthogonal to each other. The light control panels 31 and 32 excluding the reflection surfaces 31a and 32a are made of an acrylic material transmitting the laser beams. The reflection surfaces 31a and 32a are made of a metal material reflecting the laser beams.

A principle of focusing a plurality of laser beams emitted from a point P1 on the microlens array 2a at a point P2 forming a part of the stereoscopic projection image 101 by the plane-symmetric imaging element 3 is now simply described.

Suppose that two laser beams L1 and L2 are emitted from the point P1 on the microlens array 2a to different positions in the plane-symmetric imaging element 3, as shown in FIG. 7. The laser beam L1 emitted from the point P1 on the microlens array 2a to the plane-symmetric imaging element 3 is incident from the side of the light control panel 31 of the plane-symmetric imaging element 3 and thereafter is reflected by the reflection surface 31a of the light control panel 31 thereby being incident on the side of the light control panel 32 from the side of the light control panel 31. Furthermore, the incident laser beam is reflected by the reflection surface 32a of the light control panel 32 and is emitted to the outside of the plane-symmetric imaging element 3. Although not shown, the emission angle of this laser beam L1 emitted from the plane-symmetric imaging element 3 (an angle between the plane-symmetric imaging element 3 and the laser beam L1 emitted from the plane-symmetric imaging element 3) is equal to the incidence angle of the laser beam L1 incident on the plane-symmetric imaging element 3 (an angle between the plane-symmetric imaging element 3 and the laser beam L1 incident on the plane-symmetric imaging element 3). The laser beam L1 passes through substantially the same locus in a plan view before the incidence on the plane-symmetric imaging element 3 and after the emission from the plane-symmetric imaging element 3. Similarly to the laser beam L1, the incidence angle of the laser beam L2 incident on the plane-symmetric imaging element 3 and the emission angle of the laser beam L2 emitted from the plane-symmetric imaging element 3 are equal to each other, and the laser beam L2 passes through substantially the same locus in the plan view before the incidence and after the emission. Therefore, the laser beams L1 and L2 pass through the same point P2 after the emission from the plane-symmetric imaging element 3. This point P2 is formed at a position plane-symmetric to the point P1 about the plane-symmetric imaging element 3. Thus, the laser beams are diffused from a plurality of point light sources on the microlens array 2a, whereby the stereoscopic projection image 101 is projected onto the plane-symmetric position opposite to the microlens array 2a with respect to the plane-symmetric imaging element 3.

According to the first embodiment, as hereinabove described, the stereoscopic image projection apparatus 100 is provided with the microlens array 2a diffusing the laser beams in the state where the diffusion angle of the laser beams from the scanning projector 1 is controlled to the prescribed angle and the plane-symmetric imaging element 3 to which the microlens array 2a applies the laser beams whose diffusion angle is controlled, projecting the stereoscopic projection image 101 onto the position plane-symmetric to the microlens array 2a by internally reflecting the laser beams from the microlens array 2a and emitting the laser beams to the opposite side to the microlens array 2a. Thus, the microlens array 2a diffuses the laser beams whose diffusion angle is controlled to the prescribed angle α, whereby emission of the laser beams in a direction other than an intended direction can be suppressed. Therefore, generation of the laser beams not reaching the plane-symmetric imaging element 3 can be suppressed, and the energy loss resulting from the laser beams not reaching the plane-symmetric imaging element 3 can be reduced. Consequently, the light use efficiency of the laser beams from the scanning projector 1 is increased, whereby the luminance of the stereoscopic projection image 101 projected by the plane-symmetric imaging element 3 can be increased. Furthermore, the microlens array 2a is arranged to be inclined with respect to the plane-symmetric imaging element 3, whereby the stereoscopic projection image 101 can be projected onto the position plane-symmetric to the microlens array 2a with respect to the plane-symmetric imaging element 3.

In addition, the stereoscopic image projection apparatus 100 is provided with the scanning projector 1 emitting the laser beams, whereby the laser beams have high directivity unlike light of a liquid crystal display, and hence diffusion of the laser beams in all directions can be suppressed. Thus, the energy loss can be reduced.

According to the first embodiment, as hereinabove described, the microlens array 2a is configured to apply substantially all of the laser beams to the plane-symmetric imaging element 3 by controlling the diffusion angle of the laser beams. Thus, substantially all of the laser beams are applied to a region on the plane-symmetric imaging element 3, and hence the energy loss of light can be easily suppressed.

According to the first embodiment, as hereinabove described, the plurality of lens portions 21 are formed on the surface of the microlens array 2a and are arranged in the matrix to be adjacent to each other. Thus, the lens portions 21 are arranged in the large area of the surface of the microlens array 2a, and hence the light use efficiency can be further increased.

According to the first embodiment, as hereinabove described, regions between the adjacent lens portions 21 are flattened. Thus, the surface shape of the microlens array 2a can be simplified, and hence the microlens array 2a can be easily formed.

According to the first embodiment, as hereinabove described, the stereoscopic image projection apparatus 100 is provided with the Fresnel lens 4 arranged to be inclined with respect to the plane-symmetric imaging element 3, arranged to be substantially parallel to the microlens array 2a, and correcting the laser beams from the scanning projector 1 to be parallel to each other so that the laser beams from the scanning projector 1 are substantially perpendicularly incident on the microlens array 2a. Thus, the laser beams are substantially perpendicularly incident on the microlens array 2a, and hence the diffusion angle of the laser beams diffused by the microlens array 2a can be more accurately controlled to the prescribed angle α.

According to the first embodiment, as hereinabove described, the plane-symmetric imaging element 3 is provided with the light control panel 31 extending in a prescribed direction, having the reflection surfaces 31a reflecting the laser beams and the light control panel 32 having the reflection surfaces 32a, the two light control panels 31 and 32 are arranged such that the reflection surfaces 31a and 32a are orthogonal to each other while the light control panels 31 and 32 are brought into close contact with each other, and the plane-symmetric imaging element 3 is arranged at a position where the laser beams can be emitted to the position plane-symmetric to the microlens array 2a about the plane-symmetric imaging element 3 by reflecting the laser beams by the reflection surfaces 31a and 32a of the two light control panels 31 and 32. Thus, the laser beams can be emitted to the position plane-symmetric to the microlens array 2a by reflecting the laser beams a small number of times by the reflection surfaces 31a and 32a of the two light control panels 31 and 32. Therefore, the energy loss of light can be reduced, and the light use efficiency of the laser beams can be increased.

According to the first embodiment, as hereinabove described, the Fresnel lens 4 corrects the laser beams. Thus, the correcting lens correcting the laser beams can be thinned, and hence the stereoscopic image projection apparatus 100 can be downsized.

### Second Embodiment

The structure of a stereoscopic image projection apparatus 200 according to a second embodiment of the present invention is now described with reference to FIGS. 8 to 10.

In this second embodiment, the stereoscopic image projection apparatus 200 having a microlens array 2b configured to diffuse laser beams at diffusion angles α and β is described unlike in the first embodiment in which the microlens array 2a is configured to diffuse the laser beams at the diffusion angle α. The diffusion angle α is set to be larger than the diffusion angle β.

The aforementioned structure of making the diffusion angles of the microlens array 2b different from each other is based only on the surface shape of the microlens array 2b, and hence the surface shape of the microlens array 2b is mainly described below.

The microlens array 2b is provided in the form of a rectangular flat plate, as shown in FIGS. 9 and 10. The microlens array 2b has a first application region 24 and a second application region 25 to which the laser beams are applied and is configured to emit the laser beams with the diffusion angles α and β different from each other according to the first application region 24 and the second application region 25.

Specifically, the microlens array 2b is formed to have a plurality of lens portions 22a formed in the first application region 24 in a direction A1 of a first surface 20a (in a direction C1) and a plurality of lens portions 22b formed in the second application region 25 in a direction A2 of the first surface 20a and is formed such that a second surface 20b (in a direction C2) is substantially flat, as shown in FIG. 10. Furthermore, the microlens array 2b is configured such that the length E1 of each of the lens portions 22b in a direction B is equal to the length E1 of each of the lens portions 22a in the direction B, as shown in FIG. 9. In other words, the lens portions 22a are formed elliptically in a plan view, and the lens portions 22b are formed circularly in the plan view. The lens portions 22a and 22b each have a convex shape in a side view.

The microlens array 2b is configured such that the length E2 of each of the lens portions 22b in a direction A is smaller than the length E1 of each of the lens portions 22a in the direction A. Furthermore, the microlens array 2b is formed by covering (plane-filling) the first application region 24 and the second application region 25 with the plurality of lens portions 22a and 22b, respectively, in the plan view. In the microlens array 2b, the plurality of lens portions 22a of the first application region 24 and the plurality of lens portions 22b of the second application region 25 are arranged in a matrix such that the pitches of the adjacent lens portions are equal to each other. As shown in FIG. 10, the surface 20a of the microlens array 2b in the direction C2 is configured to receive the laser beams emitted from a scanning projector 1 (see FIG. 8) and corrected to be parallel to each other by a Fresnel lens 4.

According to the second embodiment, in the microlens array 2b, the lens portions 22a and 22b whose shapes are different from each other cover the first application region 24 and the second application region 25, respectively, to form the surface shape, as described above. Consequently, the microlens array 2b is configured to be capable of diffusing the laser beams at the diffusion angle α by refracting the laser beams by the lens portions 22a covering the surface 20a in the first application region 24 in the direction A1. Furthermore, the microlens array 2b is configured to be capable of diffusing the laser beams at the diffusion angle β smaller than the diffusion angle α by refracting the laser beams by the lens portions 22b covering the surface 20a in the second application region 25 in the direction A2. In other words, the microlens array 2b is formed in such a surface shape that the diffusion angle β in the second application region 25 emitting the laser beams to the side of a plane-symmetric imaging element 3 far away from the microlens array 2b becomes smaller than the diffusion angle α in the first application region 24 emitting the laser beams to the side of the plane-symmetric imaging element 3 close to the microlens array 2b.

According to the second embodiment, an application region on the plane-symmetric imaging element 3 in a direction X in the case of the diffusion angle β is smaller than an application region on the plane-symmetric imaging element 3 in the direction X in the case of the diffusion angle α, as shown in FIG. 8, as compared with the case where the laser beams are emitted from the second application region 25 with the diffusion angle α (the case of the first embodiment). Therefore, in the microlens array 2b, the diffusion angle with respect to a region of the plane-symmetric imaging element 3 far away from the microlens array 2b to which the laser beams are applied is reduced, whereby a part of an end 3a of the plane-symmetric imaging element 3 far away (in a direction X1) from the microlens array 2b is unnecessary, and hence the plane-symmetric imaging element 3 can be reduced in size.

The microlens array 2b is formed by bonding a first lens part 26a including the lens portions 22a and a second lens part 26b including the lens portions 22b to each other, as shown in FIGS. 9 and 10. Thus, in the microlens array 2b, the first application region 24 and the second application region 25 having the diffusion angles different from each other can be easily formed on the surface 20a simply by bonding the components including the lens portions 22a and 22b with the different diffusion angles to each other.

The remaining structure of the stereoscopic image projection apparatus 200 according to the second embodiment is similar to that of the stereoscopic image projection apparatus 100 according to the aforementioned first embodiment.

According to the second embodiment, as hereinabove described, the stereoscopic image projection apparatus 200 is provided with the microlens array 2b diffusing the laser beams in a state where the diffusion angles of the laser beams from the scanning projector 1 are controlled to prescribed angles and the plane-symmetric imaging element 3 to which the microlens array 2b applies the laser beams whose diffusion angles are controlled, projecting a stereoscopic projection image 101 onto a position plane-symmetric to the microlens array 2b by internally reflecting the laser beams from the microlens array 2b and emitting the laser beams to an opposite side to the microlens array 2b. Thus, the light use efficiency of the laser beams from the scanning projector 1 is increased, whereby the luminance of the stereoscopic projection image 101 projected by the plane-symmetric imaging element 3 can be increased. Furthermore, the microlens array 2b is arranged to be inclined with respect to the plane-symmetric imaging element 3, whereby the stereoscopic projection image 101 can be projected onto the position plane-symmetric to the microlens array 2b with respect to the plane-symmetric imaging element 3.

According to the second embodiment, as hereinabove described, the microlens array 2b is configured to emit the laser beams with the different diffusion angles by forming the surface shape by covering the first application region 24 and the second application region 25 with the lens portions 22a and 22b whose shapes are different from each other. Thus, the diffusion angles can be controlled according to the first application region 24 and the second application region 25 of the microlens array 2b, and hence the laser beams can be diffused at the different diffusion angles according to positions in the plane-symmetric imaging element 3.

According to the second embodiment, as hereinabove described, the microlens array 2b is formed in such a surface shape that the diffusion angle β in the second application region 25 emitting the laser beams to the side of the plane-symmetric imaging element 3 far away from the microlens array 2b becomes smaller than the diffusion angle α in the first application region 24 emitting the laser beams to the side of the plane-symmetric imaging element 3 close to the microlens array 2b. Thus, the region on the plane-symmetric imaging element 3 to which the laser beams are applied can be reduced in size on the side far away from the microlens array 2b, and hence the plane-symmetric imaging element 3 can be reduced in size. Consequently, the stereoscopic image projection apparatus 200 can be downsized.

According to the second embodiment, as hereinabove described, the application region of the microlens array 2b is formed of the first application region 24 emitting the laser beams to the side of the plane-symmetric imaging element 3 close to the microlens array 2b with the relatively large diffusion angle α and the second application region 25 emitting the laser beams to the side of the plane-symmetric imaging element 3 far away from the microlens array 2b with the relatively small diffusion angle β. Thus, diffusion of the laser beams is suppressed on the side far away from the microlens array 2b while application of the laser beams to only a small region on the plane-symmetric imaging element 3 is suppressed by diffusing the laser beams to a wide range on the side close to the microlens array 2b, whereby the region on the plane-symmetric imaging element 3 to which the laser beams are applied can be reduced in size.

According to the second embodiment, as hereinabove described, the microlens array 2b is formed by bonding the first lens part 26a corresponding to the first application region 24 and the second lens part 26b corresponding to the second application region 25 to each other. Thus, the first application region 24 and the second application region 25 having the different diffusion angles can be easily formed simply by bonding the first lens part 26a and the second lens part 26b to each other.

According to the second embodiment, as hereinabove described, on a surface inclined with respect to the plane-symmetric imaging element 3, the lens portions 22a of the first application region 24 are formed elliptically to extend in the direction B parallel to the plane-symmetric imaging element 3, and the lens portions 22b of the second application region 25 are formed circularly. Thus, the lens portions 22a and 22b are formed in the curved smooth surface shapes, and hence the stereoscopic projection image 101 can be projected without unevenness.

According to the second embodiment, as hereinabove described, the microlens array 2b is formed to extend in the direction B parallel to the plane-symmetric imaging element 3 and in the direction A orthogonal to the direction B, inclined with respect to the plane-symmetric imaging element 3 and is configured such that the width of each of the lens portions 22b in the direction A is larger than the width of each of the lens portions 22a from the first application region 24 toward the second application region 25 on the surface inclined with respect to the plane-symmetric imaging element 3. Thus, the diffusion angles of the laser beams can be adjusted by varying the widths of the lens portions 22a and 22b in the direction A, and hence an increase in the size of the microlens array 2b in a thickness direction can be suppressed.

According to the second embodiment, as hereinabove described, the microlens array 2b is formed such that the thickness thereof in a direction orthogonal to the direction B and the direction A is uniform. According to this structure, the microlens array 2b can be easily formed.

The remaining effects of the second embodiment are similar to those of the aforementioned first embodiment.

### Third Embodiment

The structure of a stereoscopic image projection apparatus 300 according to a third embodiment of the present invention is now described with reference to FIGS. 8, 11, and 12.

In this third embodiment, the stereoscopic image projection apparatus 300 having a microlens array 2c configured to diffuse laser beams at a diffusion angle in the range of at least α and not more than β is described unlike in the second embodiment in which the microlens array 2b is configured to diffuse the laser beams at the diffusion angles α and β.

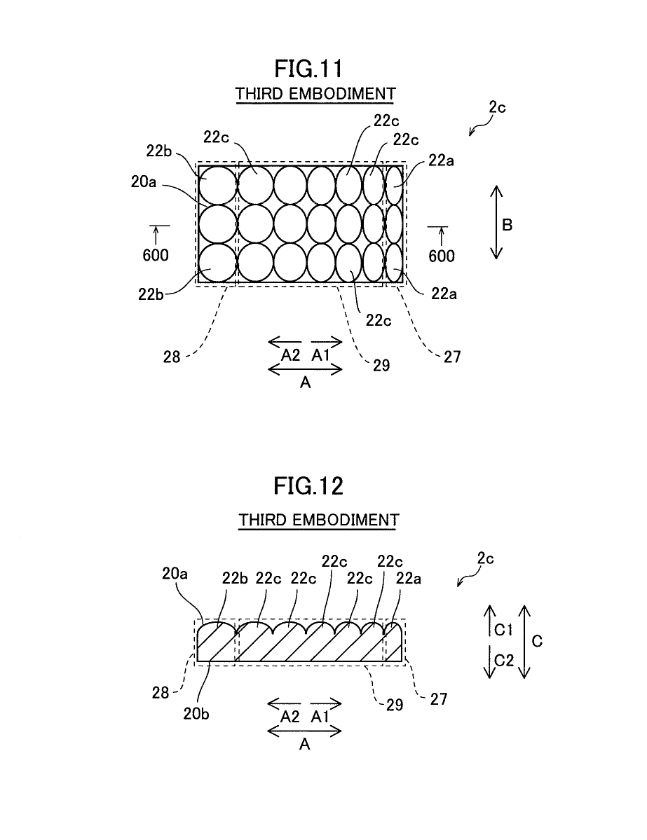

The microlens array 2c is formed of a first application region 27 arranged in a direction A1 where the diffusion angle of the laser beams is α, a second application region 28 arranged in a direction A2 where the diffusion angle of the laser beams is β, and a third application region 29 arranged between the first application region 27 and the second application region 28 where the diffusion angle of the laser beams is at least α and not more than β, as shown in FIGS. 11 and 12. The microlens array 2c is configured such that the diffusion angle of the third application region 29 is gradually reduced from the first application region 27 (the diffusion angle is at least α and not more than β) toward the second application region 28.

The microlens array 2c is formed to have convex lens portions 22c in a side view in the third application region 29 of a first surface 20a (in a direction C1), as shown in FIGS. 11 and 12. These lens portions 22c are formed such that the shapes thereof in a plan view gradually change from elliptical shapes to circular shapes from the first application region 27 toward the second application region 28.

The remaining structure of the stereoscopic image projection apparatus 300 according to the third embodiment is similar to that of the stereoscopic image projection apparatus 100 according to the aforementioned first embodiment.

According to the third embodiment, as hereinabove described, the stereoscopic image projection apparatus 300 is provided with the microlens array 2c diffusing the laser beams in a state where the diffusion angles of the laser beams from a scanning projector 1 are controlled to prescribed angles and the plane-symmetric imaging element 3 to which the microlens array 2c applies the laser beams whose diffusion angles are controlled, projecting a stereoscopic projection image 101 onto a position plane-symmetric to the microlens array 2c by internally reflecting the laser beams from the microlens array 2c and emitting the laser beams to an opposite side to the microlens array 2c. Thus, the light use efficiency of the laser beams from the scanning projector 1 is increased, whereby the luminance of the stereoscopic projection image 101 projected by the plane-symmetric imaging element 3 can be increased. Furthermore, the microlens array 2c is arranged to be inclined with respect to the plane-symmetric imaging element 3, whereby the stereoscopic projection image 101 can be projected onto the position plane-symmetric to the microlens array 2c with respect to the plane-symmetric imaging element 3.

According to the third embodiment, as hereinabove described, the microlens array 2c is configured such that the diffusion angles are gradually reduced from the first application region 27 toward the second application region 28. Thus, the diffusion angles are not sharply reduced in a boundary between the first application region 27 and the second application region 28, and hence projection of the boundary between the first application region 27 and the second application region 28 into the stereoscopic projection image 101 can be suppressed.

The remaining effects of the third embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the lens portions of the microlens array are formed circularly or elliptically in each of the aforementioned first to third embodiments, the present invention is not restricted to this. According to the present invention, the lens portions may alternatively be formed in a shape other than the circular shape or the elliptical shape, such as a polygon shape, for example.

While the microlens array has such a surface shape that the diffusion angle in the application region emitting the laser beams to the side of the plane-symmetric imaging element far away from the microlens array becomes smaller than the diffusion angle in the application region emitting the laser beams to the side of the plane-symmetric imaging element close to the microlens array in each of the aforementioned second and third embodiments, the present invention is not restricted to this. According to the present invention, the microlens array may alternatively have such a surface shape that the diffusion angle in the application region emitting the laser beams to the side of the plane-symmetric imaging element close to the microlens array becomes smaller than the diffusion angle in the application region emitting the laser beams to the side of the plane-symmetric imaging element far away from the microlens array, for example.

While the Fresnel lens is utilized to correct the laser beams to be parallel to each other in each of the aforementioned first to third embodiments, the present invention is not restricted to this. According to the present invention, a lens other than the Fresnel lens may alternatively be used to correct the laser beams to be parallel to each other, for example.

While the two or three application regions making the diffusion angles different from each other are formed on the microlens array in each of the aforementioned second and third embodiments, the present invention is not restricted to this. According to the present invention, four or more application regions of the laser beams may alternatively be formed.

While the plane-symmetric imaging element is formed in the stacked manner by bringing the two transparent flat plate-shaped light control panels into close contact with each other and bonding the same to each other in each of the aforementioned first to third embodiments, the present invention is not restricted to this.

What is claimed is:

1. A stereoscopic image projection apparatus comprising:
a projection portion scanning and emitting laser beams to project a stereoscopic projection image;
a microlens array diffusing the laser beams in a state where a diffusion angle of the laser beams from the projection portion is controlled to a prescribed angle; and
a plane-symmetric imaging element to which the microlens array applies the laser beams whose diffusion angle is controlled, projecting the stereoscopic projection image onto a position plane-symmetric to the microlens array by internally reflecting the laser beams from the microlens array and emitting the laser beams to an opposite side to the microlens array,
the microlens array arranged to be inclined with respect to the plane-symmetric imaging element.

2. The stereoscopic image projection apparatus according to claim 1, wherein
the microlens array is configured to apply substantially all of the laser beams to the plane-symmetric imaging element by controlling the diffusion angle of the laser beams.

3. The stereoscopic image projection apparatus according to claim 1, wherein
the microlens array includes a plurality of lens portions formed on a surface thereof and is arranged in a matrix such that the lens portions are adjacent to each other.

4. The stereoscopic image projection apparatus according to claim 3, wherein
a region between the lens portions adjacent to each other is flattened.

5. The stereoscopic image projection apparatus according to claim 1, further comprising a correcting lens arranged to be inclined with respect to the plane-symmetric imaging element, arranged to be substantially parallel to the microlens array, and correcting the laser beams from the projection portion to be parallel to each other so that the laser beams from the projection portion are substantially perpendicularly incident on the microlens array.

6. The stereoscopic image projection apparatus according to claim 1, wherein
the microlens array has a plurality of application regions of the laser beams and is configured to emit the laser beams with different diffusion angles by having different surface shapes on the microlens array according to the plurality of application regions.

7. The stereoscopic image projection apparatus according to claim 6, wherein
the microlens array has such a surface shape that a diffusion angle in an application region emitting the laser beams to a side of the plane-symmetric imaging element far away from the microlens array becomes smaller than a diffusion angle in an application region emitting the laser beams to a side of the plane-symmetric imaging element close to the microlens array.

8. The stereoscopic image projection apparatus according to claim 7, wherein
the application regions of the microlens array include a first application region emitting the laser beams to the side of the plane-symmetric imaging element close to the microlens array with a relatively large diffusion angle and a second application region emitting the laser beams to the side of the plane-symmetric imaging element far away from the microlens array with a relatively small diffusion angle.

9. The stereoscopic image projection apparatus according to claim 8, wherein
the microlens array includes a first lens part corresponding to the first application region and a second lens part corresponding to the second application region bonded to each other.

10. The stereoscopic image projection apparatus according to claim 8, wherein
the microlens array includes a plurality of lens portions formed on a surface thereof, and
on the surface inclined with respect to the plane-symmetric imaging element, a lens portion of the first application region is formed elliptically to extend in a first direction parallel to the plane-symmetric imaging element, and a lens portion of the second application region is formed circularly.

11. The stereoscopic image projection apparatus according to claim 8, wherein
the microlens array is configured such that the diffusion angles are gradually reduced from the first application region toward the second application region.

12. The stereoscopic image projection apparatus according to claim 11, wherein
the microlens array is formed to extend in a first direction parallel to the plane-symmetric imaging element and in a second direction orthogonal to the first direction, inclined with respect to the plane-symmetric imaging element and is configured such that widths of lens portions in the second direction are increased from the first application region toward the second application region on a surface inclined with respect to the plane-symmetric imaging element.

13. The stereoscopic image projection apparatus according to claim 12, wherein
the microlens array is formed such that a thickness thereof in a direction orthogonal to the first direction and the second direction is uniform.

14. The stereoscopic image projection apparatus according to claim 1, wherein
the plane-symmetric imaging element includes two light control panels extending in a prescribed direction, having reflection surfaces reflecting the laser beams,
the two light control panels are arranged such that the reflection surfaces are orthogonal to each other while the two light control panels are brought into close contact with each other, and
the plane-symmetric imaging element is arranged at a position where the laser beams can be emitted to the position plane-symmetric to the microlens array about the plane-symmetric imaging element by reflecting the laser beams by the reflection surfaces of the two light control panels.

15. The stereoscopic image projection apparatus according to claim 5, wherein
the correcting lens includes a Fresnel lens.

16. An optical module comprising:
a microlens array diffusing laser beams in a state where a diffusion angle of the laser beams from a projection portion scanning and emitting the laser beams to project a stereoscopic projection image is controlled to a prescribed angle; and
a plane-symmetric imaging element to which the microlens array applies the laser beams whose diffusion angle is controlled, projecting the stereoscopic projection image onto a position plane-symmetric to the microlens array by internally reflecting the laser beams from the microlens array and emitting the laser beams to an opposite side to the microlens array,
the microlens array arranged to be inclined with respect to the plane-symmetric imaging element.

17. The optical module according to claim 16, wherein
the microlens array is configured to apply substantially all of the laser beams to the plane-symmetric imaging element by controlling the diffusion angle of the laser beams.

18. The optical module according to claim 16, further comprising a correcting lens arranged to be inclined with respect to the plane-symmetric imaging element, arranged to be substantially parallel to the microlens array, and correcting the laser beams from the projection portion to be parallel to each other so that the laser beams from the projection portion are substantially perpendicularly incident on the microlens array.

19. The optical module according to claim 16, wherein
the microlens array has a plurality of application regions of the laser beams and is configured to emit the laser beams with different diffusion angles by having different surface shapes on the microlens array according to the plurality of application regions.

20. The optical module according to claim 19, wherein
the microlens array has such a surface shape that a diffusion angle in an application region emitting the laser beams to a side of the plane-symmetric imaging element far away from the microlens array becomes smaller than a diffusion angle in an application region emitting the laser beams to a side of the plane-symmetric imaging element close to the microlens array.
